(19) United States
(12) Patent Application Publication
(10) Pub. No.: US 2007/0024720 A1
(43) Pub. Date: Feb. 1, 2007

(54) Image taking apparatus

(75) Inventor: Kouhei Awazu, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/496,464

(22) Filed: Aug. 1, 2006

(30) Foreign Application Priority Data
Aug. 1, 2005 (JP) 2005-222427

(51) Int. Cl. H04N 9/73

(52) U.S. Cl. 348/223.1

(57) ABSTRACT

An image taking apparatus has a light emitting section, a color temperature circuit and a system control circuit. The light emitting section includes LEDs respectively emitting each color of red, green and blue. In response to the result of color temperature measurement in the color temperature circuit, the system control circuit instructs the light emitting section to emit fill-in light, by controlling light intensity of the LEDs to be combined, according to any one of the four color temperatures of sunny weather, cloudy weather, tungsten light and fluorescent light.

### BACKGROUND OF THE INVENTION

1. Field of the Invention

The present invention relates to an image taking apparatus that includes an imaging device and generates an image signal by forming a subject image on the imaging device.

2. Description of the Related Art

Typically, an image taking apparatus is provided with a light emitting section such as a xenon tube that emits flash directed to a subject in sync with shooting operation, so that the flash can reach the subject. Such a xenon tube is known to emit flash of the color in accordance with the color temperature similar to that of sun light. Therefore, when shooting is performed using flash of the xenon tube, it is possible to obtain a shot image with the color that is close to the color of a subject an operator perceives.

However, under certain circumstances, for example, in cloudy weather, the color of a shot image does not match the actual color of the subject even with flash of the xenon tube or even when shot outdoors. A gap between a color of a subject and that of the shot image of the subject is prominent when shooting is performed indoors under lighting conditions such as an incandescent lamp or fluorescent lamp.

More particularly, when shooting is performed under a light source of an incandescent lamp (tungsten light) using flash of the xenon tube, the obtained shot image does not match the actual color of the subject under the incandescent lamp, because the incandescent lamp has the color (white tinged with red) with a lower color temperature than that of the flash of a xenon tube.

Such a problem can be addressed, if white balance circuit provided in a digital camera can offset difference between the color temperatures of the flash of the xenon tube and the light of the incandescent lamp by performing white balance adjustment using light received by light receiving elements of an imaging device.

However, white balance adjustment is typically employed in the limited range of lighting conditions such as sunny weather, cloudy weather, tungsten light (incandescent lamp) and fluorescent light. Thus, in automatic white balance, usually one of the conditions that is closest to the color temperature of a subject before fill-in light is emitted is selected to perform white balance adjustment. Therefore, in the above case, white balance adjustment would be performed in accordance with an incandescent lamp, whereas flash of the xenon tube that has different color temperature from the incandescent lamp is to be emitted, which would bring a shot image with the color different from the color of a subject that an operator perceives under an incandescent lamp.

Incidentally, development of blue light emitting diode has enabled light emitting diodes (LED) to emit white light, leading to wide applications of LEDs such as a light emitting device to emit fill-in light for shooting. For example, Japanese Patent Publication Application No. 2003-233109 proposes a technique to use LEDs to irradiate a subject for close-range shooting. This technique enables LEDs as a light emitting device to emit fill-in light in accordance with the color temperature of the subject.

### SUMMARY OF THE INVENTION

The present invention has been made in view of the above circumstances, and provides an image taking apparatus provided with a light emitting section that emits fill-in light in accordance with white balance.

An image taking apparatus that performs shooting by forming a subject image on an imaging device and generating image signals by the imaging device, the image taking apparatus including:

a white balance processing section that performs white balance processing in accordance with shooting under any one of predetermined plural kinds of light sources;

a color temperature measurement section that measures a color temperature of a field prior to shooting; and

a light emitting section that is capable of emitting fill-in light of different kinds of colors in accordance with different color temperatures of the plural kinds of light sources, the different color temperatures capable of being used by white balance processing in the white balance processing section;

wherein the light emitting section emits, at the time of shooting, fill-in light of any one of the different kinds of colors, in accordance with the color temperature measured in the color temperature measurement section.

According to the image taking apparatus, the light emitting section emits fill-in light of one of the different kinds of colors, based on the measured color temperature of the field in the color temperature measurement section. After shooting, image signals obtained by emission of the fill-in light can be subjected to desired white balance processing based on the color temperature associated with the color of the fill-in light.

If the color of emitted fill-in light is in accordance with any one color temperature of the plural kinds of light sources that are predetermined in the white balance processing section, desired white balance processing can be performed.

Thus, the light emitting section of the image taking apparatus of the invention can emit fill-in light in accordance with white balance.

Preferably, the white balance processing section performs white balance processing suitable for shooting under each of sunny weather, cloudy weather, tungsten light and fluorescent light, and the light emitting section is capable of emitting fill-in light of a color in accordance with each color temperature of sunny weather, cloudy weather, tungsten light and fluorescent light.

As mentioned above, conventional image taking apparatuses are likely to have white balance function for limited range of light sources such as sunny weather, cloudy weather, tungsten light and fluorescent light.

Accordingly, if the light emitting section is adopted to emit fill-in light of the same number of different colors as the number of kinds of the light sources, desired white balance can be performed.

More preferably, the light emitting section has plural light emitting elements that respectively and independently serve to emit fill-in light of each of the different kinds of colors.

This allows that any one of the light emitting elements is selected, based on the measured color temperature in the color temperature measurement section, to independently emit fill-in light of the color in accordance with the measured color temperature.

Moreover, as the light emitting elements respectively and independently serve to emit fill-in light based on the measured color temperature, it is possible to simplify the configuration of the drive section for driving the respective light emitting elements, for example, by on/off switching. Additionally, the light emitting section can be also configured by using an LED that emits white light.

Further, the light emitting section may have plural light emitting elements that respectively emit any one color of red, green and blue, and emits fill-in light of the different kinds of colors by controlling and combining light intensity of the light emitting elements.

When the light emitting elements respectively emit three primary colors of red, green and blue, the light emitting elements are adapted to emit fill-in color of the same number of colors as the number of the color temperatures used by white balance, by combining controlled light intensity.

Thus, the light emitting section can be configured by using such light emitting elements.

It is also possible that the color temperature measurement section measures an average color temperature of a field of a subject image formed on the imaging device.

A subject for shooting is likely to be illuminated by a light source of a color temperature different from those of sunny weather, cloudy weather, tungsten light and fluorescent light. Or the subject may be illuminated by mixed light sources. If the average temperature of the field of the subject image formed on the imaging device is measured, one of the four light sources closest to the average temperature is selected and fill-in light in accordance with the light source is emitted, so that desired white balance is performed.

Preferably, the color temperature measurement section measures a color temperature of a substantial center of a field of a subject image formed on the imaging device.

Usually, shooting is performed with a center of a field in focus. Thus, if the color of fill-in light is selected based on the measured color temperature of the center of the field of the subject image, it is possible to emit fill-in light in accordance with the color temperature of the center of the field in focus, so that desired white balance is performed.

More preferably, the color temperature measurement section measures a color temperature of each region obtained by dividing a field of a subject image formed on the imaging device into plural regions, wherein the measured color temperature of each of the regions is associated with a color temperature to be used for white balance processing in the white balance processing section and the associated color temperature covered by the largest number of regions is set as the color temperature of the field used for white balance processing.

As mentioned above, the invention can realize the image taking apparatus with the light emitting section that emits fill-in light in accordance with white balance.

### BRIEF DESCRIPTION OF THE DRAWINGS

The invention will be described with reference to the accompanying figures of which:

FIG. 1 shows an external perspective view of a digital camera according to one embodiment of the invention;

FIG. 2 is a block diagram indicating an internal configuration of the digital camera shown in FIG. 1;

FIG. 3 shows arrangement of three light emitting diodes shown in FIG. 2;

FIG. 4 shows a flowchart indicating a series of operation procedures performed by a system control circuit shown in FIG. 2, including emission of fill-in light;

FIG. 5 shows a state in which there are mixed light sources;

FIG. 6 is another modification of the embodiment of the invention; and

FIG. 7 shows arrangement of four light emitting diodes shown in FIG. 6; and

FIG. 8 shows a flowchart indicating a series of operation procedures performed by a system control circuit shown in FIG. 6, including emission of fill-in light.

### DETAILED DESCRIPTION OF THE INVENTION

Embodiments of the present invention will be described below with reference to the drawings.

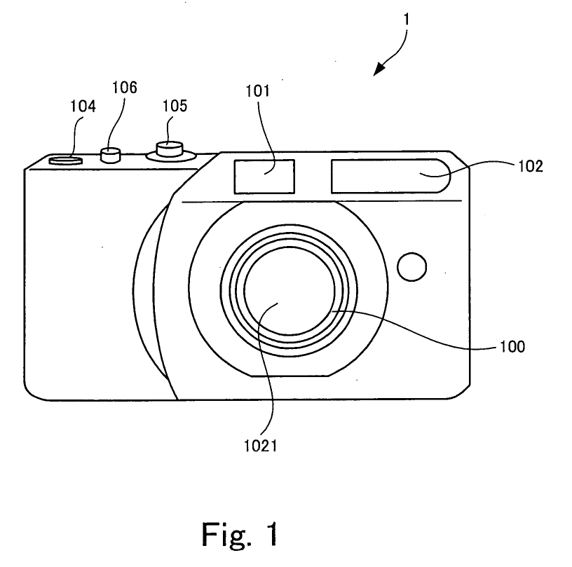

FIG. 1 shows an external perspective view of a digital camera 1 according to an embodiment of the invention.

The digital camera 1 of FIG. 1 has a lens barrel 100 at a substantial center thereof, and a shooting lens 1021 incorporated in the lens barrel 100. A finder 101 and a fill flash window 102 next to the finder 101 are disposed above the lens barrel 100 on the front face of the digital camera 1. When a system control circuit determines that fill flash is required for shooting, fill flash is emitted from the fill flash window 102 directed to a subject.

On the top face of the digital camera 1, a shutter button 104, a mode dial 105 and a single/continuous frame shooting switch 106 are disposed.

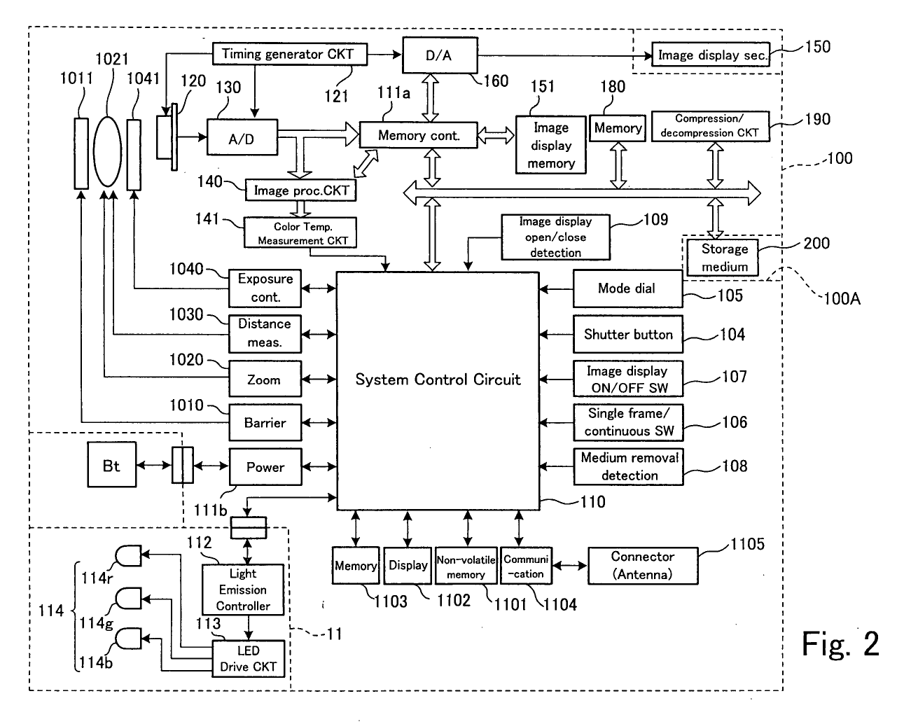

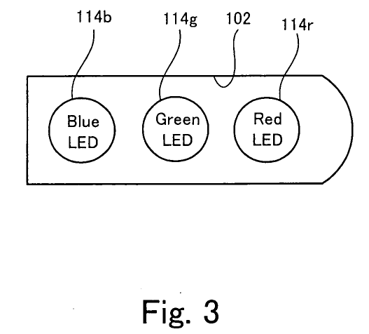

FIG. 2 is a block diagram indicating an internal configuration of the digital camera 1 and FIG. 3 shows arrangement of three light emitting diodes shown in FIG. 2.

Referring to FIG. 2, the internal configuration of the digital camera 1 will be described.

A system control circuit 110 controls all the operations of the digital camera 1. Operating members including the mode dial 105, the single/continuous frame shooting switch 106 shown in FIG. 1, and the shutter button 104 are connected to an input section of the system control circuit 110. When an operation signal is transmitted to the system control circuit 110 by operating one of the operating members, the operation corresponding to the operating member will be performed.

The digital camera 1 of the embodiment has a removable storage medium 200 i.e., a memory card loaded in a medium loading chamber 100A, so that image data representing a shot image is stored in the memory card 200. Accordingly, the digital camera 1 has a storage medium removal detection mechanism 108 to detect whether or not the storage medium 200 is attached to the medium load chamber 100A. Further, on the back face of the digital camera 1, disposed are an image display ON/OFF switch 107 and an image display section open/close detection mechanism 109 that detects opening and closing of a door to protect the front of a display panel. All the signals from the storage medium removal detection mechanism 108, the image display ON/OFF switch 107 and the image display section open/close detection mechanism 109 are sent to the system control circuit 110 that performs the operation corresponding to the respective received signals.

Further, the system control circuit 110 instructs a zoom control mechanism 1020 to move a zoom lens incorporated in the shooting lens 1021 in response to an operation of a zoom switch (not shown) as well as instructs a TTL distance measurement mechanism 1030 to move a focus lens incorporated in the shooting lens 1021 according to the result of TTL distance measurement.

Additionally, the system control circuit 110 performs TTL metering as well as TTL distance measurement based on the image signal generated in a CCD imaging device 120 (hereafter referred as CCD imaging device). In the digital camera 1 of the embodiment, image data generated in the CCD solid state imaging device 120 is supplied through an image processing circuit 140 to a color temperature measurement circuit 141 that measures color temperature. Base on the result of the color temperature measurement, a white balance processing section in the system control circuit 110 sets a gain of each color amplifier to perform desired white balance adjustment.

Additionally, based on the result of the TTL metering, the system control circuit 110 instructs an exposure control mechanism 1040 to adjust aperture of a diaphragm 1041 as well as determines whether fill-light is necessity for shooting. When the necessity is determined, the system control circuit 110 instructs a light emission controller 112 to cause an LED drive circuit 113 to drive each of LEDs 114r, 114g and 114b, in accordance with the color temperature data from the color temperature measurement circuit 141, such that fill-in light is emitted directed to a subject. The color temperature data represents the relative proportion of red light, green light, and blue light. The LEDs 114r, 114g and 114b respectively emit red light, green light and blue light.

Referring to FIG. 3, the LEDs 114r, 114g and 114b are arranged in the fill flash window 102, and are caused to emit fill-in light, by controlling and combining their light intensity, according to any one of the color temperatures of sunny weather, cloudy weather, tungsten light (incandescent lamp) and fluorescent light.

Now, operation procedures of the digital camera 1 provided with a light emitting section 11 shown in FIG. 2 is briefly described below.

Upon turn-on of the digital camera 1, in accordance with the procedure of the operation program stored in a nonvolatile memory 1101, the system control circuit 110 integrally controls the whole operation of the digital camera 1 to initiate shooting operation. In the embodiment, for the purpose of saving power consumption, power from a battery is not supplied to each element of the digital camera 1 through a power supply control unit 111b until the system control circuit 110 detects turn-on of a power switch (not shown) of the digital camera 1, while power from the battery is always supplied to the system control circuit 110.

With power supplied from the battery to each element of the digital camera 1, the digital camera 1 is ready to operate as follows.

As shown in FIG. 2, the lens barrel 100 shown in FIG. 1 has the shooting lens 1021 incorporating a zoom lens and a focus lens and the diaphragm 1041 for light quantity adjustment. In the embodiment, a lens barrier 1011 is disposed to protect the shooting lens 1021. The lens barrier 1011 is configured so as to be opened, at turn-on of the power switch, exposing the shooting lens 1021 as shown in FIG. 1.

If the mode dial 105 is set to a shooting mode at the turn-on of the power switch, image signals representing a subject image that is formed on the CCD imaging device 120 through the shooting lens 1021 are thinned at predetermined intervals i.e., at intervals of 33 ms to be output. The output signals representing a through image (live view) (hereafter referred to as a though image signal) are converted from analog signals into digital signals in an A/D conversion circuit 130 and then supplied to the image processing circuit 140 under control of a memory control section 111a. In the image processing circuit 140, the through image signals consisting of RGB signals are converted into those of YC signals and then provided to and stored in an image display memory 151 under control of the memory control section 111a. One frame of the through image signals stored in the memory control section 111a is read to be supplied to a D/A conversion circuit 160 where the through image signals are subjected to analog conversion, and then supplied to an image display section 150. In the embodiment, the image display memory 151 is provided to temporarily store at least two frames of through image signals, so that through image signals stored in the image display memory are supplied by one frame, at predetermined intervals, to the image display section 150. Accordingly, a through image is timely displayed on the image display section 150.

Now, details of operations of each element will be described in accordance with the processing procedure of through image signals.

Under control of the system control circuit 110, image signals representing a subject image formed on the CCD imaging device 120 are output as through image signals, in accordance with a timing signal from the timing generator circuit 121, e.g., at intervals of 33 ms, to the A/D conversion circuit 130 in the subsequent stage. Analog-to-digital converted through image signals are then supplied to the image processing circuit 140 under control of the memory control section 111a. The image processing circuit 140 separates the digital-converted through image signals into R color signals, G color signals and B color signals, which then are supplied to the color temperature measurement circuit 141, and are converted to YC signals by color transformation matrix to be supplied to the image display memory 151 in the subsequent stage. R color signals, G color signals and B color signals supplied to the color temperature measurement circuit 141 are subjected to color temperature measurement and supplied to the system control circuit 110, in which a gain of each color amplifier is set to perform white balance of image signals. When white balance is to be performed, the respective measured color temperature becomes closest to one of the four color temperatures of sunny weather, cloudy weather, tungsten light (incandescent lamp) and fluorescent light, based on the gain set in each color amplifier.

Meanwhile, YC-converted signals are supplied to and stored in the image display memory 151. In the image display memory 151, at least two frames of through image signals are stored and one frame of through image signals stored earlier is output to the D/A conversion circuit 160, where the through image signals are converted into analog signals to be displayed on the image display section 150.

As described before, the system control circuit 110 instructs the TTL distance measurement mechanism 1030 to move the focus lens (incorporated in the shooting lens 1021) so as to be always positioned in a focus according to the result of the TTL measurement as well as instructs the zoom control mechanism 1020, in response to an operation of the zoom switch (not shown), to move the zoom lens (incorporated in the shooting lens 1021) so as to be positioned in accordance with the operated zoom magnification.

When a through image in focus and magnified in accordance with the magnification operated by the zoom switch is displayed, image taking processing starts by pressing the shutter button 104.

The system control circuit 110 instructs the timing generator circuit 121 to output an exposure start signal to the CCD imaging device 120, timed to pressing of the shutter button 104. If the system control circuit 110 determines, based on the TTL measurement, the necessity of fill-in light, it causes the light emitting section 11 to emit, in sync with pressing of the shutter button 104, fill-in light having the color closest to the one selected from the four color temperatures of sunny weather, cloudy weather, tungsten light (incandescent lamp) and fluorescent light, according to the color temperature detected in the color temperature measurement circuit 141.

In the embodiment, color temperature data obtained by the color temperature measurement circuit 141 is supplied to the system control circuit 110 that determines which of sunny weather, cloudy weather, tungsten light (incandescent lamp) and fluorescent light has the color temperature closest to the detected color temperature. Based on the result, the system control circuit 110 performs white balance and causes the light emitting section 11 to emit fill-in light in accordance with white balance.

The light emitting section 11 is configured by the light emission controller 112, the LED drive circuit 113 and the LED group 114. The LEDs 114r, 114g and 114b respectively emit red light, green light and blue light, light intensity of which are controlled to be combined and are caused to emit fill-in light according to the color temperature of any one of sunny weather, cloudy weather, tungsten light (incandescent lamp) and fluorescent light. The LED drive circuit 113 controls light intensity of the three LEDs by adjusting the respective current value with which the three LEDs are driven.

Upon emission of such fill-in light to allow desired white balance, the system control circuit 110 instructs the timing generator 121 to output an exposure end signal to the CCD imaging device 120.

Then, the CCD imaging device 120, in sync with the exposure end signal, outputs image signals to the A/D conversion circuit 130, in which the image signals are converted into digital signals, and then are supplied to the memory 180 via the bus under control of the memory control section 111a. After all the image signals that are composed of all the pixels provided in the CCD imaging device 120 are stored in the memory 180, the image signals are read out to be subjected to white balance adjustment and gamma correction in the system control circuit 110. Further, after white balance adjustment and gamma correction is applied to image signals obtained by emission of fill-in light according to white balance, the image signals are supplied via the bus to the image processing circuit 140 to be converted into YC signals. The YC-converted image signals are then supplied to a compression/decompression circuit 190 to be compressed and stored in the storage medium 200 i.e., a memory card.

The mechanism mentioned above enables emission of fill-in light according to white balance, so that desired white balance adjustment is performed in the system control circuit 110. Thus, it is possible to securely obtain image data having a color in accordance with the color temperature of the field.

Additionally, the digital camera 1 has a communication device 1104, a display device 1102, memory 1103 and nonvolatile memory 1101. The communication device 1104 is provided on the flank on the camera body 1 and enables radio communications with the outside when an antenna is attached thereto via a cable.

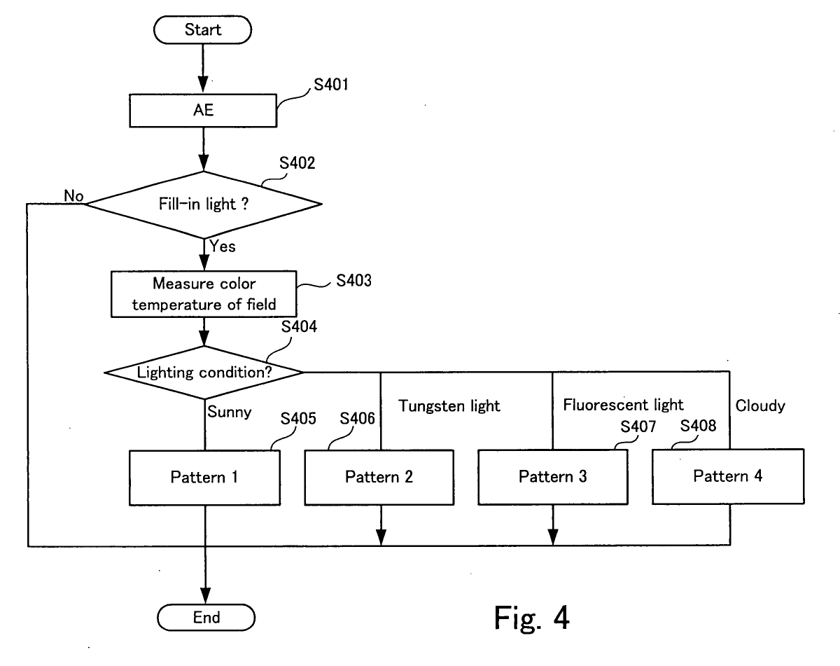

FIG. 4 shows a flowchart indicating a series of image taking operation procedures performed by the system control circuit 110.

More particularly, FIG. 4 shows operation procedures on how light intensity of three LEDs are controlled and combined and the light emitting section 11 is caused to emit fill-in light in accordance with any one of the color temperature of sunny weather, cloudy weather, tungsten light (incandescent lamp) and fluorescent light.

Firstly, at step S401, automatic exposure (AE) is performed. Next, the flow goes to step S402 in which it is determined, based on the result of the TTL metering, whether fill-in light is necessary.

If fill-in light is not necessary (NO), the flow ends. If fill-in light is necessary (YES), the flow goes to step S403 in which the color temperature of the field is measured in the color temperature measurement circuit 141. In step S404, the light condition is determined based on the result of the color temperature measurement. If it is determined that it is sunny but the field is a little shady, the flow goes to step S405 in which the combination pattern 1 of the LED 114r(red), the LED 114g(green) and the LED 114b(blue) will be emitted. If it is determined to be indoor shooting under tungsten light, the flow goes to step S406 and the combination pattern 2 of the same will be emitted. If it is determined to be indoor shooting under fluorescent light, the flow goes to step S407 and the combination pattern 3 of the same will be emitted. If it is determined to be outdoor shooting in cloudy weather, the flow goes to step S408 and the combination pattern 4 of the same will be emitted. After any of steps S405, S406, S407 and S408, the flow ends.

The above mentioned mechanism enables emission of fill-in light in accordance with white balance, thereby realizing an image taking apparatus capable of performing desired white balance adjustment.

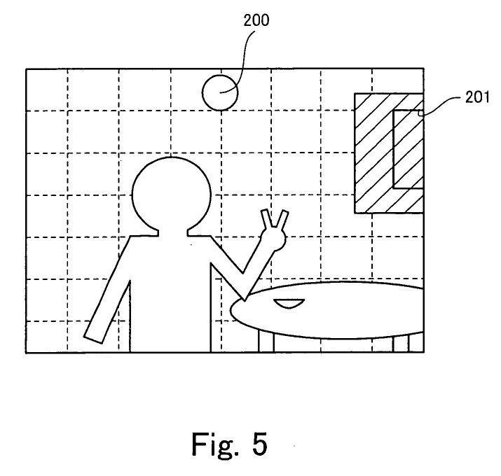

FIG. 5 shows a state in which there are mixed light sources.

More particularly, FIG. 5 shows the state in which, when indoor shooting is about to be performed under a light bulb 200, light also enters from a fluorescent light disposed on, for example, an electric pole near a window 201.

In other words, shooting is to be performed under mixed light sources of tungsten light of the light bulb 200 and the fluorescent light (hatched portion).

According to the embodiment, the color temperature measurement circuit 141 (see FIG. 2) measures color temperature of each region that is obtained by dividing the field of the subject image formed on the CCD imaging device 120 into predetermined number of regions. In FIG. 5, the color temperature of fluorescent light covers, at most, about two regions (the hatched portion), and the color temperature of tungsten light covers most of the regions of the field.

In the case shown in FIG. 5, in response to the color temperature measurement of each region of the field by the color temperature measurement circuit 141, the system control circuit 110 associates the measured color temperature of each of the regions with a color temperature used for white balance adjustment in the white balance processing section. The system control circuit 110 may set the associated color temperature covered by the largest number of regions as the color temperature of the field used for white balance adjustment.

For example, in the case shown in FIG. 5, the system control circuit 110 receives the results of color temperature measurement of each region from the color temperature measurement 141 and instructs the light emitting section 11 to emit fill-in light in accordance with the color temperature of tungsten light covered by the largest number of regions of the field. After emission of the fill-in light, the system control circuit 110 applies white balance adjustment according to the color temperature of tungsten light to the image signals from the CCD imaging device 120.

If white balance adjustment according to the color temperature of tungsten light is applied to the whole field, the color of the whole field is adjusted to the one in accordance with the color temperature of tungsten light. Meanwhile, the color of the hatched portion of FIG. 5 is adjusted to the one in accordance with the color temperature of fluorescent light that an operator perceives under tungsten light. Thus, a shot image can reproduce the color of the subject that an operator perceives.

In the embodiment, combination of the color temperature measurement circuit 141 and the system control circuit 110 is an example of “the color temperature measurement section” of the invention.

Considering that shooting is performed usually focusing on the substantial center of the field of the subject image formed on the CCD, the color temperature measurement circuit 141 and the system control circuit 110 may only measure color temperature of the center of the field.

This shortens the time required for color temperature measurement but is still effective to perform to the whole field white balance adjustment according to the color temperature of measured regions, in the case of FIG. 5, of tungsten light.

Further, the system control circuit 110 may calculate, in response to the results of color temperature measurement in the color temperature measurement circuit 141, the average color temperature of the whole field of the subject image formed on the CCD 120.

This is also effective to perform to the whole field white balance adjustment according to the color temperature of measured regions, in the case of FIG. 5, of tungsten light.

As mentioned above, “the color temperature measurement section” configured by the color temperature measurement circuit 141 and the system control circuit 110 of the embodiment may calculate the average color temperature of the field (variation 1), measure the color temperature of the substantial center of the field (variation 2), or specify the color temperature covered by the largest number of regions of the field (variation 3). The color temperature measurement section of the embodiment may employ all the variations but to use only one selected from the three variations.

As described above, it is possible to provide an image taking apparatus with a light emitting section that can emit fill-in light in accordance with white balance.

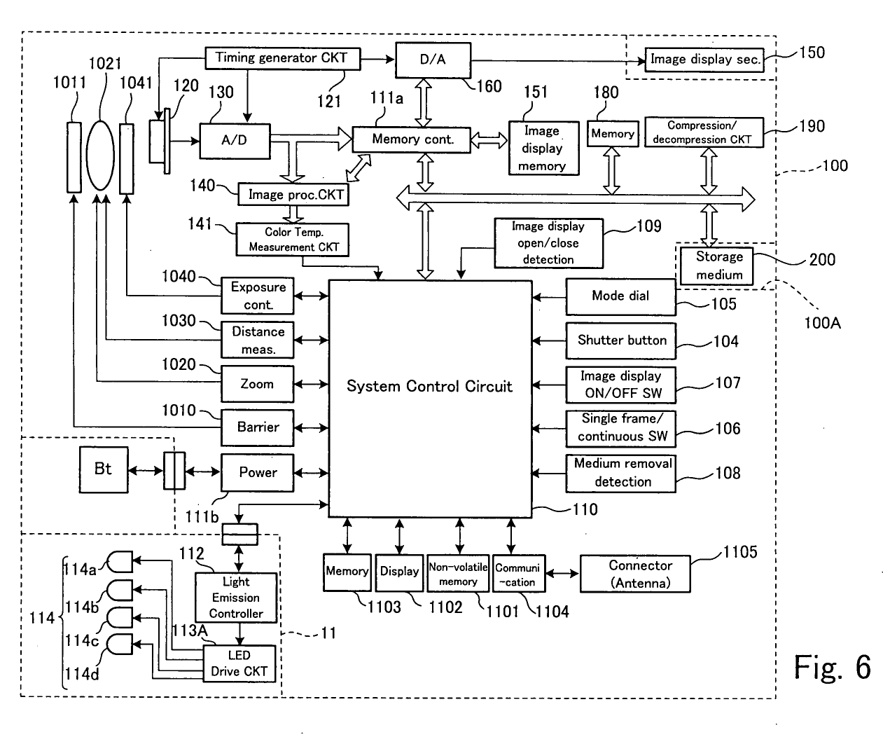

FIG. 6 through FIG. 8 show another modification of the embodiment of the invention.

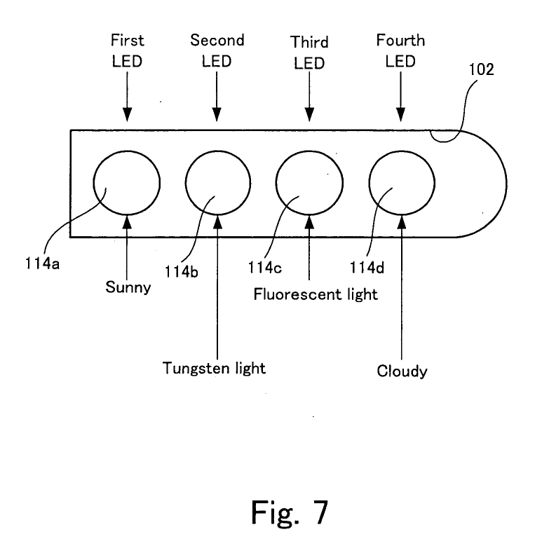

FIG. 6 shows an internal configuration of an image taking apparatus according to another modification of the invention. The elements of FIG. 6 are identical to those in FIG. 2 except that four LED 114a through 114d are provided so that LEDs can emit fill-in light respectively and independently in accordance with the color temperature of any one of sunny weather, cloudy weather, tungsten light (incandescent lamp) and fluorescent light. FIG. 7 shows arrangement of four LEDs 114a through 14d.

In the embodiment shown in FIG. 2 and FIG. 3, light intensity of the three LEDs are controlled to be combined so as to emit fill-in light of four kinds of colors, while in the modification shown in FIG. 6 and FIG. 7, four LEDs 114a through 114d respectively and independently emit fill-in light of four kinds of colors in accordance with the color temperatures of any one of sunny weather, cloudy weather, tungsten light (incandescent lamp) and fluorescent light.

Therefore, only one of the four LEDs needs to be emitted for fill-in light, which eliminates need to control light intensity of the three LEDs as in the case of FIG. 2 and FIG. 3, thereby simplifying the configuration of the LED drive circuit 113A.

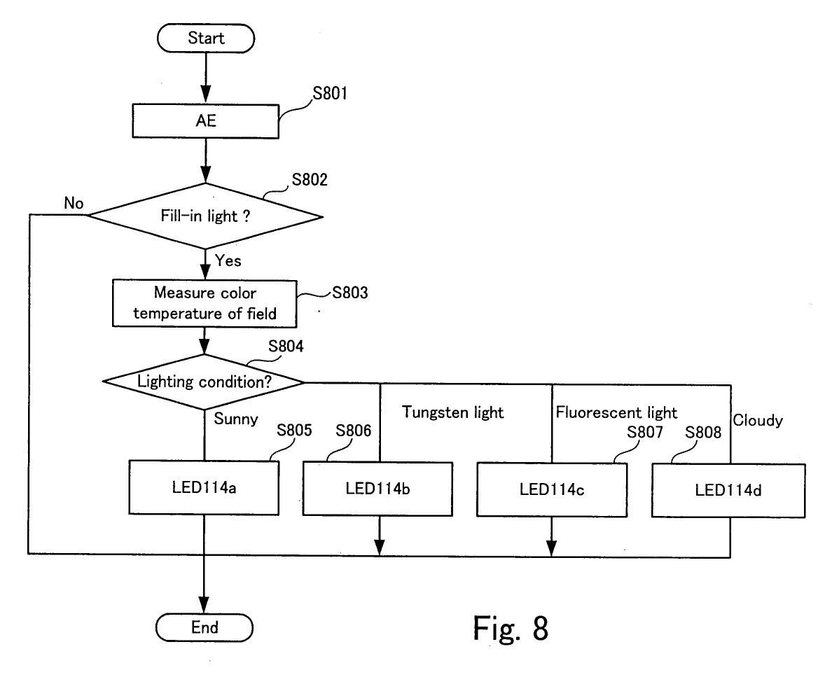

FIG. 8 shows a flowchart indicating a series of image taking operation procedures performed by the system control circuit 110 shown in FIG. 6, including emission of fill-in light.

More particularly, FIG. 8 shows operation procedures on how the light emitting section 11 with four LEDs 114a through 114d is caused to emit fill-in light in accordance with the color temperature of sunny weather, cloudy weather, tungsten light (incandescent lamp) or fluorescent light.

Firstly, at step S801, automatic exposure (AE) is performed. Next, the flow goes to step S802 in which it is determined, based on the result of the TTL metering, whether fill-in light is necessary.

If fill-in light is not necessary (NO), the flow ends. If fill-in light is necessary (YES), the flow goes to step S803 in which the color temperature of the field is measured in the color temperature measurement circuit 141. In step S804, lighting condition is determined based on the result of the color temperature measurement. If it is determined that it is sunny but the field is a little shady, the flow goes to step S805 in which the LED 114a will be emitted. If it is determined to be indoor shooting under tungsten light, the flow goes to step S806 and the LED 114b will be emitted. If it is determined to be indoor shooting under fluorescent light, the flow goes to step S807 and the LED 114c will be emitted. If it is determined to be outdoor shooting in cloudy weather, the flow goes to step S808 and the LED 114d will be emitted. After any of steps S805, S806, S807 and S808, the flow ends.

The above configuration also realizes an image taking apparatus with a light emitting section that emits fill-in light in accordance with white balance.

What is claimed is:

1. An image taking apparatus that performs shooting by forming a subject image on an imaging device and generating image signals by the imaging device, the image taking apparatus comprising:
a white balance processing section that performs white balance processing in accordance with shooting under any one of predetermined plural kinds of light sources;
a color temperature measurement section that measures a color temperature of a field prior to shooting; and
a light emitting section that is capable of emitting fill-in light of different kinds of colors in accordance with different color temperatures of the plural kinds of light sources, the different color temperatures capable of being used by white balance processing in the white balance processing section;
wherein the light emitting section emits, at the time of shooting, fill-in light of any one of the different kinds of colors, in accordance with the color temperature measured in the color temperature measurement section.

2. The image taking apparatus according to claim 1, wherein the white balance processing section performs white balance processing suitable for shooting under each of sunny weather, cloudy weather, tungsten light and fluorescent light, and the light emitting section is capable of emitting fill-in light of a color in accordance with each color temperature of sunny weather, cloudy weather, tungsten light and fluorescent light.

3. The image taking apparatus according to claim 1, wherein the light emitting section has plural light emitting elements that respectively and independently serve to emit fill-in light of each of the different kinds of colors.

4. The image taking apparatus according to claim 1, wherein the light emitting section has plural light emitting elements that respectively emit any one color of red, green and blue, and emits fill-in light of the different kinds of colors by controlling and combining light intensity of the light emitting elements.

5. The image taking apparatus according to claim 1, wherein the color temperature measurement section measures an average color temperature of a field of a subject image formed on the imaging device.

6. The image taking apparatus according to claim 1, wherein the color temperature measurement section measures a color temperature of a substantial center of a field of a subject image formed on the imaging device.

7. The image taking apparatus according to claim 1, wherein the color temperature measurement section measures a color temperature of each region obtained by dividing a field of a subject image formed on the imaging device into plural regions, wherein the measured color temperature of each of the regions is associated with a color temperature used for white balance processing in the white balance processing section, and the associated color temperature covered by the largest number of regions is set as the color temperature of the field used for white balance processing.
